(19) United States
(12) Patent Application Publication
(10) Pub. No.: US 2015/0248378 A1
(43) Pub. Date: Sep. 3, 2015

(54) READABILITY ON MOBILE DEVICES

(71) Applicant: Konica Minolta Laboratory U.S.A., Inc., San Mateo, CA (US)

(72) Inventor: Kurt N. Nordback, Portland, OR (US)

(73) Assignee: Konica Minolta Laboratory U.S.A., Inc., San Mateo, CA (US)

(21) Appl. No.: 14/193,709

(22) Filed: Feb. 28, 2014

(51) Int. Cl. G06F 17/21; H04W 4/02

(52) U.S. Cl. CPC G06F 17/212; H04W 4/027; G06F 17/214

(57) ABSTRACT

A method involves operating a mobile device including a screen. The method includes detecting, by the mobile device, an acceleration of the mobile device; receiving, by the mobile device and after detecting the acceleration, a request to access a document including multiple default settings; and modifying, in response to detecting the acceleration and receiving the request, a display of the document on the screen.

### BACKGROUND

A mobile device is becoming a common medium for consumption of media. In particular, mobile devices are popular for viewing written documents and data, such as web pages (e.g., social media and blogs), newspapers, word processing documents, spreadsheets, etc. When a user is in motion, such as when a user is walking or is a passenger in a vehicle, the screen of the mobile device may be difficult to read as the mobile device is moving relative to the user's eyes.

There have been attempts in the past to improve readability of mobile devices when the user is in motion. However, most of these attempts simply scale the font size of the document that is already being displayed as soon as motion is detected. This can be very frustrating to the user. Regardless, users still desire to view documents on their mobile devices while they are in motion.

### SUMMARY

In general, in one aspect, the invention relates to a method of operating a mobile device. The method comprises: detecting, by the mobile device, an acceleration of the mobile device; receiving, by the mobile device and after detecting the acceleration, a request to access a document comprising a plurality of default settings; and modifying, in response to detecting the acceleration and receiving the request, a display of the document on the screen.

In general, in one aspect, the invention relates to a mobile device. The mobile device comprises: a screen; a sensor configured to detect an acceleration of the mobile device; a buffer storing a document comprising a plurality of default settings; and a modification module (MM) configured to modify a display of the document on the screen in response to the acceleration and a request to access the document.

In general, in one aspect, the invention relates to a non-transitory computer readable medium (CRM) storing instructions for operating a mobile device comprising a screen. The instructions comprise functionality for: detecting an acceleration of the mobile device; receiving, after detecting the acceleration, a request to access the document comprising a plurality of default settings; and modifying, in response to detecting the acceleration and receiving the request, the display of the document.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIGS. 3-4 show an example in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a mobile device, a method of operating a mobile device, and a CRM storing instructions for operating a mobile device. Specifically, once it is detected that the mobile device is accelerating and that the acceleration satisfies one or more criteria, the display (i.e., appearance) of a document on the mobile device is modified to improve readability of the document. In other words, the display (i.e., appearance) of a document on the mobile device is modified to improve readability of the document while the mobile device (and thus most likely user) are in motion. Modification of the display (i.e., appearance) of the document may include modifying a default setting (e.g., increasing font size) of the document and then executing a layout of the document with the modified default setting. Additionally or alternatively, modification of the display (i.e., appearance) of the document may include increasing a zoom factor of the display. In one or more embodiments of the invention, the modification is only applied to documents requested by the user after the acceleration is detected. In one or more embodiments of the invention, the modification is applied to a document while the document is being viewed by a user.

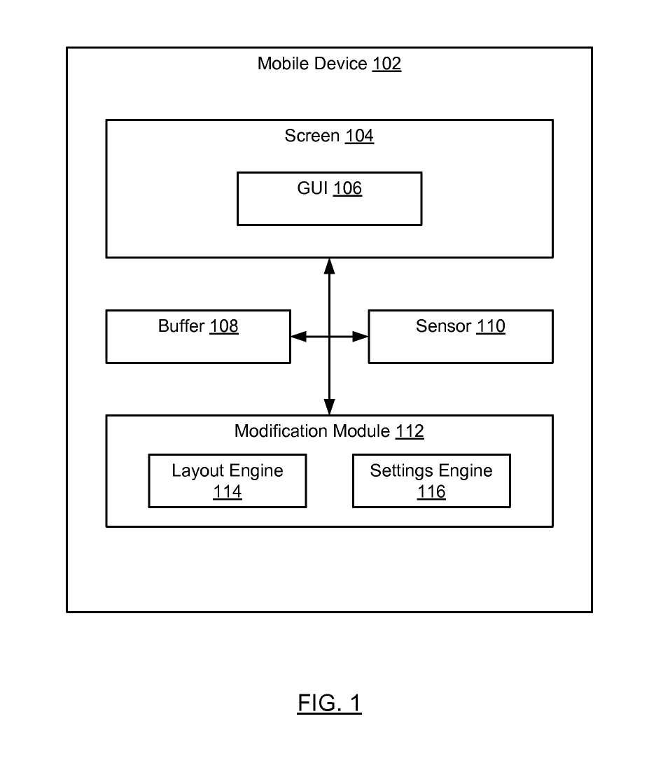

FIG. 1 shows a system in accordance with one or more embodiments of the invention. As shown in FIG. 1, the system includes a mobile device (102). The mobile device (102) may be any portable computing device that includes a processor, memory, input device(s) (e.g., keyboard, touchscreen, microphone) and output device(s) (e.g., screen (104)). Embodiments of the invention may be implemented on virtually any type of mobile device regardless of the platform being used. For example, the mobile device (102) may be a laptop computer, a smart phone, a personal digital assistant, a tablet computer, an electronic reader (i.e., e-reader), or any other type of hardware device.

In one or more embodiments of the invention, the mobile device (102) includes a screen (104), a buffer (108), a sensor (110), and a modification module (112). Each component is described below.

In one or more embodiments of the invention, the mobile device includes the sensor (110). The sensor (110) is a device that includes functionality to detect and/or measure acceleration of the mobile device (102). For example, the sensor (110) may include an accelerometer (not shown). The sensor (110) may also be configured to compare the magnitude, direction, and/or duration of any measured/detected acceleration with one or more thresholds. In one or more embodiments of the invention, the sensor (110) communicates/reports the magnitude, direction, and/or duration of a detected acceleration only if the thresholds are satisfied (e.g., the threshold is exceeded). In one or more embodiments of the invention, the sensor (110) communicates/reports the magnitude, direction, and/or duration of a detected acceleration regardless of whether the thresholds are satisfied. These thresholds (and other criteria/conditions) may be preset by the manufacturer of the mobile device (102). Additionally or alternatively, these thresholds may be modified (i.e., customized) by the user of the mobile device (102) at any time.

In one or more embodiments of the invention, the buffer (108) may correspond to any type of memory or long-term storage (e.g., hard drive). The buffer (108) is configured to store documents (or at least portions of documents) that have been requested by the user for viewing. Examples of requested documents include web pages (e.g., hypertext markup language (HTML) files), portable document format (PDF) files, Open Office XML files or files generated using any markup language, slide show presentations, spreadsheets, etc.

In one or more embodiments of the invention, the documents requested by a user include one or more default settings. A default setting is an automatically assigned property that affects the display (i.e., appearance) of a document. For example, a default setting may include font size (e.g., 12 points), font type (e.g., Times New Roman), margins, any color in the document (e.g., background color and font color), etc. The documents requested by the user may include one or more graphical elements (e.g., advertisements, artistic/decorative borders, etc.) that can be excluded (i.e., not displayed) without affecting the content/information in the document to be conveyed to the reader/user. In one or more embodiments of the invention, when the document is specified using a markup language, the text characters, images, graphical elements, and default settings are recorded/identified as attributes within the tags of the document markup language.

In one or more embodiments of the invention, the modification module (112) includes a settings engine (116). The settings engine (116) includes functionality to modify (e.g., replace, substitute, increase, decrease, etc.) one or more default settings of a document and/or remove graphical elements (e.g., advertisements, artistic/decorative borders, etc.) of a document. Specifically, settings engine (116) modifies one or more default settings and/or removes graphical elements of the requested document to increase the readability of the document while the mobile device and its user are in motion. The number of removals and the number/types of modifications made to the default settings may depend on the magnitude, direction, and/or duration of the acceleration.

In one or more embodiments of the invention, documents are classified as having either a fixed layout or a variable layout. A fixed layout document has only one correct rendering of the document, irrespective of the size of the viewing window. A variable layout document may vary based on the size (e.g., width) of the viewing window. Both PDF files and OOXML files are examples of fixed layout documents. An HTML file is an example of a variable layout document. Although both fixed layout documents and variable layout documents have default settings, some default settings within fixed layout documents cannot be modified. Specifically, in the case of fixed layout documents, only modifications to default settings that do not affect the layout (e.g., changing font colors, changing background colors, removing some graphical elements that do not affect layout (e.g., backgrounds images, borders, etc.)) are permitted. In contrast, in the case of variable layout documents, modifications to default settings that affect the layout (e.g., changing the font size, removing some graphical elements that do affect layout (e.g., advertisements, images/graphics that are inline with the text, etc.)) are permitted.

For example, if the magnitude of the acceleration is low, the font size of text may be increased by 2 pts from the default font size specified in the variable layout document. As another example, if the acceleration is high, the font size of the text may be increased by 4 pts from the default font size specified in the document, and one or more graphical elements in the document may be removed. In one or more embodiments of the invention, these modifications and removals take place before the document is rendered (i.e., before execution of a layout of the document).

In one or more embodiments of the invention, the modification module (112) modifies or resets (to their original values) one or more default settings of a document after the document is already displayed. Specifically, the user may not be pleased with the modification(s) to the display (i.e., appearance) and may request that some or all of the modifications be reduced or even eliminated (discussed below).

In one or more embodiments of the invention, the modification module (112) includes the layout engine (114). The layout engine (114) includes functionality to execute a layout of the document following any modifications and/or removals performed by the modification module (112). In other words, the layout engine (114) calculates the positions (e.g., coordinates) of all text, graphics, etc. in the document based on the modified settings. In one or more embodiments of the invention, removal of a graphical element means the graphical element is not submitted to the layout engine for placement or the layout engine ignores the graphical element during the layout. Those skilled in the art, having the benefit of this detailed description will appreciate that the presence or absence of a graphical element changes the positions of the remaining text, graphics, etc. on the rendered (i.e., displayed) page.

In one or more embodiments of the invention, the screen (104) may correspond to an organic light emitting diode (OLED) display, a liquid-crystal display (LCD), or any device that displays output from the mobile device. In the case of a touch screen, the screen (104) may also act as an input. In one or more embodiments of the invention, the screen (104) displays or includes functionality to display a graphical user interface (GUI) (106).

In one or more embodiments of the invention, the GUI (106) includes any number of graphical elements/widgets (e.g., radio buttons, checkboxes, dropdown lists, buttons, etc.) to interact with a user of the mobile device (102). The GUI (106) may be visible when the document is being displayed. The GUI (106) may be visible before the document is displayed. In one or more of the embodiments, the GUI (106) includes a reset widget. By manipulating the reset widget, the user may request that one or more modifications to the display (i.e., appearance) of the document be reduced or undone. In other words, by manipulating the reset widget, the user may request that the document be displayed according to its default settings. For example, the reset widget may correspond to a slider where the left most position may correspond to the default settings of a document and the right most position may correspond to a request to keep all of the modifications to the display (i.e., appearance) of the document. In one or more embodiments of the invention, a handle on the slider may be moved by a user from right to left or left to right. By manipulating the position of the handle on the slider, the user may undo any modification of a default setting to a document (e.g., slide the handle to the left most position) or adjust the modification (e.g., slide the handle between the left most position and right most position).

For example, a default setting may specify a font size of 12 pts. The modified font size may be 18 pts. Once the document is displayed to the user with the 18 pts font size, the handle on the slider may be moved by a user towards the left to select any font size between 12 pts and 18 pts. Those skilled in the art, having the benefit of this detailed description, will appreciate that any request by the user to reduce or undo the modification to the display (i.e., appearance) of the document may require a new layout of the document to be executed (e.g., by the layout engine (114)).

In one or more embodiments of the invention, the GUI (106) displays a symbol to the user when the detected/measured acceleration satisfies one or more thresholds. The symbol is an indication to the user that the display (i.e., appearance) of any document that is subsequently requested will be modified to improve readability of the document. The user may select the symbol to approve. The user may select the symbol to disapprove and thus prevent any modification to the display of the document. The symbol may correspond to a button, a flashing icon, a dialog box, etc.

In one or more embodiments of the invention, it is not always possible to modify settings of the document. For example, as discussed above, fixed layout documents may prohibit modification of some default settings. In such embodiments, the display (i.e., appearance) of the document may be modified to increase readability by zooming (e.g., 150%, 200%, etc.) into the document. However, those skilled in the art, having the benefit of this detailed description, will appreciate that some content may fall outside the portion of the document that is visible on the screen because of the zooming In such embodiments, the GUI (106) may include scroll bars to shift the portion of the document that is visible on the screen and thus access this content. Zooming may be applied to both fixed layout and variable layout documents.

While FIG. 1 shows a configuration of components, other configurations may be used without departing from the scope of the invention. For example, various components may be combined to create a single component. As another example, the functionality performed by a single component may be performed by two or more components.

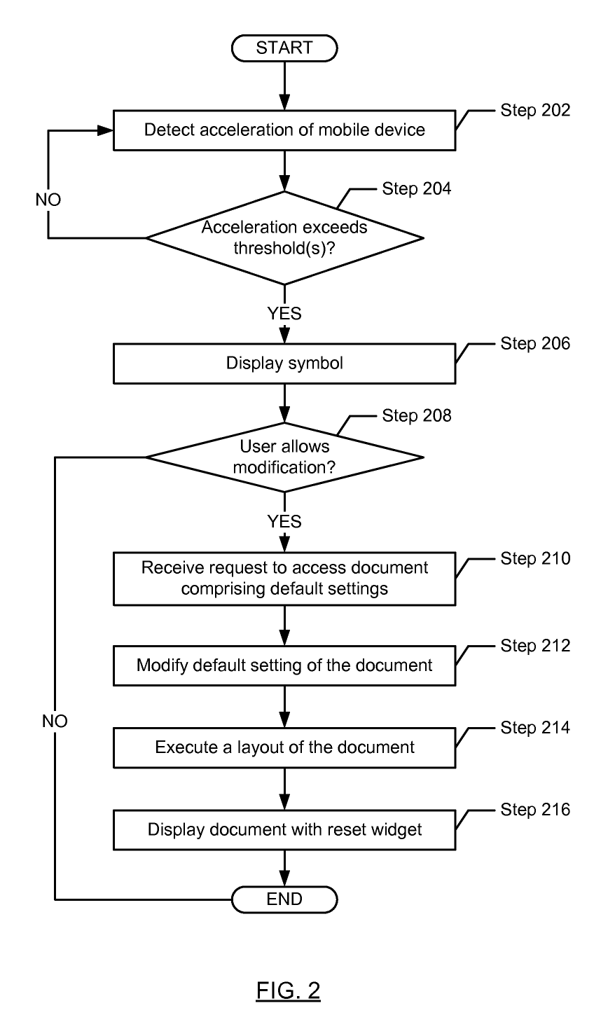

FIG. 2 shows a flowchart in accordance with one or more embodiments of the invention. One or more of the steps in FIG. 2 may be performed by the components of the mobile device (102), discussed above in reference to FIG. 1. In one or more embodiments of the invention, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

Initially, an acceleration of the mobile device is detected (Step 202). Specifically, the acceleration of the mobile device is detected using a sensor (e.g., accelerometer) that is a component of the mobile device. The magnitude, direction, and duration of the acceleration may be measured.

In Step 204, it is determined whether the acceleration satisfies (e.g., exceeds) one or more thresholds. A separate threshold may exist for magnitude, direction, and duration. When one or more of the measured magnitude, direction, and duration values satisfy (e.g., exceed) their corresponding thresholds, this is an indication that the mobile device (and thus most likely the user of the mobile device) is in motion (e.g., walking, in a moving vehicle, etc.). Moreover, when one or more of the measured magnitude, direction, and/or duration values satisfy their corresponding thresholds, these measured values are reported to other components of the mobile device. When it is determined that the acceleration satisfies one or more thresholds, the process proceeds to Step 206. When it is determined that the acceleration does not satisfy one or more thresholds (i.e., although an acceleration was detected, it was very small and/or very short and thus it is unnecessary to modify the display of a document on the mobile device), the process returns to Step 202.

In Step 206, a symbol is displayed on the screen of the mobile device. In one or more embodiments of the invention, the symbol may correspond to an icon, a dialog box, a button, or any widget to signify to a user that acceleration satisfying one or more thresholds has been detected. In one or more embodiments of the invention, the symbol is displayed within a GUI. The user may already be viewing a document when the acceleration takes place and/or when symbol is displayed. For example, the symbol may be a graphic of an odometer, and this graphic may be placed at the top right hand side of the screen of the mobile device.

In Step 208, it is determined whether the user permits modifications to the display (i.e., appearance) of a document because of the detected acceleration. A user may permit modifications by selecting the symbol within a predetermined time frame. A user may permit modifications by not selecting (i.e., ignoring) the symbol. Additionally or alternatively, a user may prohibit modifications by selecting the symbol. A user may prohibit modifications by not selecting (i.e., ignoring) the symbol. When it is determined that the user permits modifications, the process proceeds to Step 210. When it is determined that the user prohibits modifications, the process may end. In one or more embodiments of the invention, the symbol is optional and modifications to the display of subsequent documents requested by the user takes place automatically. In such embodiments, Step 208 may be omitted.

In Step 210, a request is received to access a document. The request is received after the acceleration is detected. The document may correspond to a web page (e.g., HTML file), a PDF file, a OOXML file, a file written in any markup language, a spreadsheet, a slideshow, etc. In one or more embodiments of the invention, the request to access the document may correspond to a user clicking on a link on a web page, refreshing a web page, moving back or forwards to a webpage, opening an application on a mobile device, selecting an icon, etc.

As described above, a document may include default settings that control/dictate the display of the document. For example, a document may have the following default settings: a font size of 20 pts for titles and 12 pts otherwise, one inch margins, and a background color of white and a font color of black. Another document may have the following default settings: font of Times New Roman, font size of 14 pts, and a background color of red and a font color of white. As also described above, the document may include one or more graphical elements (e.g., advertisements, artistic/decorative borders, etc.) that are not needed to convey the content of the document to the user.

In Step 212, one or more default settings of the requested document are modified (e.g., replaced, substituted, increased, decreased, etc.). As discussed above, if the document is a variable layout document, any default setting including default settings that rearrange the layout of the document (e.g., font size) may be modified. As also discussed above, if the document is a fixed layout document, only default settings that do not rearrange the layout of the document (e.g., font color, background color, etc.) may be modified. Regardless, modifications to both variable layout documents and fixed layout documents are done to effectively modify the display (i.e., appearance) of the document to improve readability of the document while the user is in motion. The number/type of modifications to the settings of the document may depend on one or more of the magnitude, direction, and duration of the measured acceleration. In the case of documents specified by a markup language, the settings may be specified within tags and modification of the settings effectively corresponds to modification of these values in the tags.

In one or more embodiments of the invention, one or more of the graphical elements (e.g., advertisements, artistic/decorative borders, etc.) in the requested documents are deleted/excluded. This may be done to modify the display (i.e., appearance) of the document to improve readability of the document while the user is in motion.

In Step 214, a layout of the document is executed in accordance with one or more embodiments of the invention. Specifically, the layout is performed after the settings have been modified and/or after the one or more graphical elements have been deleted/excluded. In one or more embodiments of the invention, executing a layout of the document includes calculating positions (co-ordinates) for text, graphics, etc. in the document. In one or more embodiments of the invention, deleting/excluding a graphical element corresponds to not submitting the graphical element to the layout engine and/or marking the graphical element such that it is ignored by the layout engine.

In one or more embodiments of the invention, rather than modifying a default setting of the document or deleting a graphical element, a modification to the display (i.e., appearance) of the document may correspond to applying a zoom factor to the displayed document. This may be done when some of the default setting of the document cannot be modified (e.g., in a fixed layout document) and/or when a graphical element cannot be deleted. In such embodiments, the zooming may force content of the document to fall outside the portion of the document that is visible on the display screen. Scroll bars may be used/needed to access this additional content.

In one or more embodiments of the invention, the layout engine may determine which objects to exclude from the layout by keywords associated with the document. In one or more embodiments of the invention a keyword may be a word or phrase that appears more than a frequency threshold. In one or more embodiments of the invention, a frequency threshold is a numerical value. For example, given a frequency threshold of three, a word or phrase that appears more than three times is considered a keyword. Any object that does not include a keyword either directly in text or indirectly, such as a tag associated with an image, may be excluded. Alternatively, an object may be excluded regardless of keywords without departing from the invention. For example, any object that is not text or an image in the main body text may be excluded.

In Step 216, the document is displayed with a reset widget. In one or more embodiments of the invention, a reset widget is displayed with the document and allows a user to reduce or undo any modifications to the document. For example, the reset widget may include a slider whose handle may move from right to left or left to right. The left most position may represent undoing a modification whereas the right most position may represent the modification that is applied. Any position between the left most and the right most positions may partially undo the modification. For example, assume a default font size is 13 pts. Prior to submission to the layout engine, the font size is changed to 20 pts. The reset widget allows the user to partially undo the modification and set the font size to any value between 13 pts and 20 pts (e.g., 16 pts). Those skilled in the art, having the benefit of this detailed description, will appreciate that manipulation of the reset widget may require a new layout of the document be executed.

In one or more embodiments of the invention, a separate reset widget may exist for each modification that is applied. For example, a first slider may exist to adjust any modification to a font size, a second slider may exist to adjust modification to an image size, and a third slider may exist to adjust the zoom factor applied to the document. In one or more embodiments of the invention, if only two states exist for a modification (i.e., apply modification or undo modification), the slider may only allow a user to move the handle to either the left most position or right most position. For example, assume a default font of a document is French Script. A modification is applied to change the font to Times New Roman when the document is displayed. A slider displayed with the document allows the user to keep the modification (i.e., remain at right most position) or undo the modification (i.e., slide the handle to the left most position).

In one or more embodiments of the invention, a reset widget may correspond to radio buttons or any widget that provides alternate options to a user for a modification that is stylistic, such as a change of color. For example, a default font color of a document is pink. A modification to display the document with a font color of black is applied. A reset widget may display showing pink as an option to undo the black font. Additionally, other colors, such as blue or grey may also be radio buttons on the reset widget.

In one or more embodiments of the invention, default settings of a document may be restored automatically once acceleration of a mobile device is no longer detected by the sensor. Alternatively, a user may be notified that acceleration is no longer detected and may choose to revert to the default settings of the document or continue to view the modification(s) of the document.

Although the process shown in FIG. 2 applies the modification to the document (or its default settings) only after a request to access the document is received, in other embodiments of the invention, the modification of the document (or its default settings) occurs gradually (i.e., continuously or almost continuously over a time interval/window) while the user is viewing the document to improve readability and avoid disturbing/disrupting the user. For example, if acceleration is detected, the document may be zoomed (i.e., magnified) by 150% over 3 seconds while the user is viewing the document. As another example, the document may be zoomed by 200% over 6 seconds while the user is viewing the document. As yet another example, if acceleration is detected, the border of the document may be removed (e.g., faded) gradually over 5 seconds while the user is viewing the document. As yet another example, if acceleration is detected, the font color(s) and background color(s) of the document may be changed gradually over 2 seconds while the user is viewing the document.

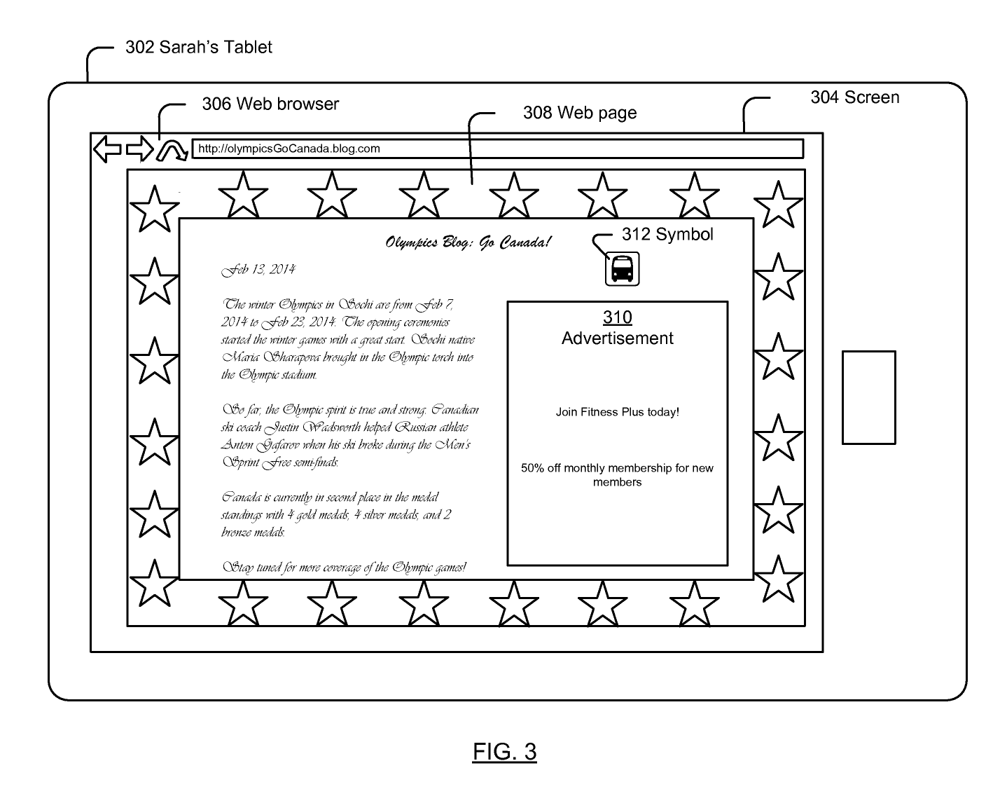

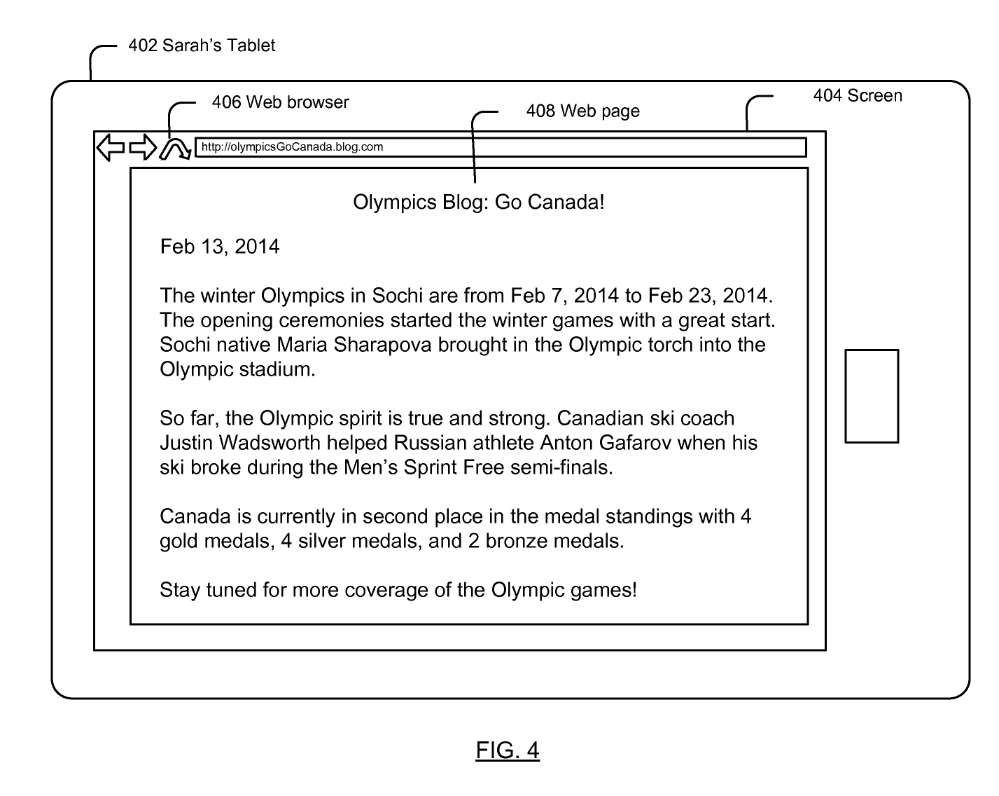

FIGS. 3-4 show an example in one or more embodiments of the invention. The following example is for explanatory purposes only and not intended to limit the scope of the invention.

Turning to FIG. 3, consider a scenario in which Sarah is commuting to a job on a bus that drives over rough terrain. The rough terrain causes the bus to move Sarah's tablet (302) relative to Sarah's eyes. The movement of Sarah's tablet (i.e., mobile device) causes reading an Olympics blog web page (308) (i.e., document) in a web browser (308) on a screen (304) of Sarah's tablet difficult.

The web page (308) includes a star border, an advertisement (310), text in a default font of Vivaldi, default font size of 10 pts for body text and default font size of 12 pts for the title. Acceleration is detected by a sensor in Sarah's tablet (302). An icon (312) (i.e., symbol) is displayed on the web page (308) to indicate to Sarah that acceleration is detected/measured. Sarah hovers a cursor over the icon (312) and the following message is displayed: “Acceleration detected. Click icon to allow modifications then click refresh button in the web browser”. Sarah clicks on the icon and then refreshes the web page (308). The result of refreshing the web page (308) is shown in FIG. 4.

Turning to FIG. 4, a web page (408) is displayed on the screen (404) of

Sarah's tablet (402) after Sarah refreshed the web browser (406) described in FIG. 3. To improve readability on Sarah's tablet (402) as Sarah commutes over the rough terrain on the bus, modifications are made to the display (i.e., appearance) of the web page (408). The default font size of 10 pts for body text is increased to 14 pts, and the default font size for the title is changed to 14 pts. The default font is changed from Vivaldi to Arial. As the star border and advertisement (i.e., advertisement (310), discussed above in reference to FIG. 3) are unnecessary graphical elements, they are excluded from the layout of the web page (408) to extend the text to the width of the screen (404) Improved readability of the web page (408) after the modifications to the default settings allow Sarah to read despite acceleration of Sarah's tablet (402).

One or more embodiments of the invention have the following advantages: the ability to modify a document to improve readability on a mobile device once the document is accessed and acceleration is detected; the ability to execute a layout of the document that excludes graphical objects; the ability to modify a document with either a fixed layout (i.e., cannot modify some default settings) or a variable layout (i.e., can modify default settings); the ability to notify a user of acceleration and prompt for permission for any modifications if access to a document is requested by a user; the ability to interact with a user to undo or partially undo a modification to the document while the document is displayed; the ability to revert any modification once acceleration is no longer detected; etc. Other embodiments of the invention may have additional advantages.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for operating a mobile device comprising a screen, comprising:
detecting, by the mobile device, an acceleration of the mobile device;
receiving, by the mobile device and after detecting the acceleration, a request to access a document comprising a plurality of default settings; and
modifying, in response to detecting the acceleration and receiving the request, a display of the document on the screen.

2. The method of claim 1, wherein modifying the display comprises:
modifying a default setting of the plurality of default settings; and
executing a layout of the document after modifying the default setting.

3. The method of claim 2, wherein the default setting is selected from a group consisting of a color of the document and a font.

4. The method of claim 2, wherein the default setting is a font size.

5. The method of claim 1, wherein modifying the display comprises:
selecting a graphical object; and
executing a layout of the document excluding the graphical object.

6. The method of claim 1, wherein modifying the display comprises:
modifying a zoom factor associated with the screen.

7. The method of claim 1, further comprising:
displaying, before modifying the display of the document, a symbol on the screen in response to detecting the acceleration; and
receiving a selection of the symbol,
wherein modifying the display is further in response to the selection.

8. The method of claim 1, further comprising:
displaying, after modifying the display of the document, a reset widget;
receiving a selection of the reset widget; and
undoing, at least partially, the modifying of the display of the document.

9. A mobile device, comprising:
a screen;
a sensor configured to detect an acceleration of the mobile device;
a buffer storing a document comprising a plurality of default settings; and
a modification module (MM) configured to modify a display of the document on the screen in response to the acceleration and a request to access the document.

10. The mobile device of claim 9, wherein the MM further comprises:
a settings engine configured to modify a default setting of the plurality of default settings in response to the acceleration; and
a layout engine configured to execute a layout of the document after the default setting is modified.

11. The mobile device of claim 10, wherein the default setting is a font size.

12. The mobile device of claim 10, wherein the default setting is selected from a group consisting of a font and a color of the document.

13. The mobile device of claim 9, further comprising:
a graphical user interface, displayed on the screen, and comprising a reset widget displayed with the document.

14. A non-transitory computer readable medium (CRM) storing instructions for operating a mobile device comprising a screen, the instructions comprising functionality for:
detecting an acceleration of the mobile device;
receiving, after detecting the acceleration, a request to access the document comprising a plurality of default settings; and
modifying, in response to detecting the acceleration and receiving the request, the display of the document.

15. The non-transitory CRM of claim 14, wherein the instructions for modifying the display comprise functionality for:
modifying a default setting of the plurality of default settings; and
executing a layout of the document after modifying the default setting.

16. The non-transitory CRM of claim 15, wherein the default setting is at least one selected from group consisting of a color of the document, a font, and a font size.

17. The non-transitory CRM of claim 14, wherein the instructions for modifying the display comprise functionality for:
selecting a graphical object; and
executing a layout of the document excluding the graphical object.

18. The non-transitory CRM of claim 14, wherein the instructions for modifying the display comprise functionality for:
modifying a zoom factor associated with the screen of the mobile device.

19. The non-transitory CRM of claim 14, the instructions further comprising functionality for:
displaying, before modifying the display of the document, a symbol on the screen of the mobile device in response to detecting the acceleration; and
receiving a selection of the symbol, wherein modification of the display of the document is further in response to the selection.

20. The non-transitory CRM of claim 14, the instructions further comprising functionality for:
displaying, after modifying the display of the document, a reset widget to at least partially undo the modifying of the display of the document.
